(19) United States
(12) Patent Application Publication
(10) Pub. No.: US 2008/0202219 A1
(43) Pub. Date: Aug. 28, 2008

(54) Device for Using with a Sensor for Improving Accuracy, and Sensor with an Improved Accuracy

(75) Inventor: Walter Schmidt, Russikon (CH)

Correspondence Address: RANKIN, HILL & CLARK LLP, 38210 Glenn Avenue, WILLOUGHBY, OH, 44094-7808, US

(73) Assignee: PLANTCARE AG, Russikon (CH)

(21) Appl. No.: 11/916,535

(22) PCT Filed: Jun. 1, 2006
(86) PCT No.: PCT/CH2006/000291

§ 371 Date: Feb. 1, 2008

(30) Foreign Application Priority Data
Jun. 7, 2005 (CH) 959/05

(51) Int. Cl. G01N 7/10

(52) U.S. Cl. 73/64.48; 73/73

(57) ABSTRACT

The invention relates to a sensor for measuring the water content or moisture content in a solid matter medium, in particular to a ground humidity sensor, as well as to a device for use with a sensor for improving its accuracy. The sensor, or at least the region of the sensor designed for measurement, is surrounded by an interface, the interface absorbing and releasing moisture, as well as designed in a mechanically flexible manner, such that the interface may be adapted to a non-constant or not clearly defined surface of the solid matter medium surrounding the sensor, i.e. to the earth. By way of this, the contact surface between the sensor and the medium is optimized, and air gaps, impressions of stones, etc., are compensated or bridged. The interface is preferably manufactured of a felt of plastic fibers, and is exchangeably attached via a sensor or sensor head.

### BACKGROUND OF THE INVENTION

The invention lies in the field of improvement of the sensor accuracy and reliability, and in particular relates to a device for use with a sensor for improving its accuracy, as well as a device for measuring the water content or humidity content in solid matter media with an improved accuracy.

### DESCRIPTION OF RELATED ART

Today, one primarily applies so-called tensiometers for the measurement of ground humidity. These measurement apparatus consist of a tube which may be closed in an airtight manner, which comprises a cap of porous ceramic at the lower end. A conventional or electronic manometer is connected at the upper end. If the tube is filled with water, then this flows to the outside through the porous ceramic cap. If the tube is inserted into a medium which may absorb water, then this produces a vacuum in the tube, which may be measured. This measurement principle however has a series of grave disadvantages as described hereinbelow.

The accuracy of the measurement depends heavily on the type of the medium surrounding the ceramic cap. It is often the case with sandy substrates, or ones which contain stones or gravel, that the contact surface between the ceramic and the surrounding earth is not defined. This means that air gaps occur, which greatly influence the measurement.

If the surrounding earth dries out, then gaps form between the ceramic and the earth, which lead to adulterated measurements.

The porous ceramic may become scaled due to limy water, and micro-organisms may colonise the ceramic. A drift of the measurement result over time occurs on account of this.

The measurement results change with a change of temperature or also of the barometric air pressure.

Since water exits the ceramic cap, the water level in the tube must be controlled again and again, and be refilled with water as the case may be.

With a size reduction of the ceramic cap, the contact surface between the ceramic and the surroundings also reduces in size, and the accuracy and the sensitivity sink accordingly.

The largest and most important factor which leads to inaccuracy of the measurement results is the basically undefined border surface between the ceramic and the surrounding medium. The same of course also applies to ground humidity sensors which are based on thermal measurement methods.

The problems of the mechanical-thermal coupling of a ground humidity sensor has already been recognised in the document DE 2536777. In order to avoid the problems of an undefined border surface, it is suggested not to carry out the measurement in the earth, but in defined artificial earth surrounding the actual measurement probe, a heating pin. The artificial earth has the same soil water tension as the actual earth to be measured. The artificial earth must imitate the characteristics of the earth as accurately as possible, wherein the soil water tension of the artificial earth is set by way of the granulation of quartz (silica) sand for example. The artificial earth however likewise has a high thermal capacity and thermal conductivity, so that the humidity measurements, in particular those by way of thermal methods, are determined by the characteristics of the artificial earth. Moreover, the artificial earth must have a certain volume, so that the border surface of earth/artificial earth which is still not so well defined and which consists of a net enveloping the artificial earth, does not play a significant role.

### SUMMARY OF THE INVENTION

It is therefore the object of the invention to increase the measurement accuracy of sensors, in particular by way of improving the interaction between the sensor and the surrounding medium.

This object is achieved by the device, the sensor and the use of the device, as are defined in the patent claims.

The invention is based on the idea of compensating differences in the surface morphology by way of the application of a standardised interface between the sensor and the surrounding medium, and by way of this, of increasing the accuracy of the sensors, in particular of ground humidity sensors, such as tensiometers for example.

Such interfaces should influence a humidity measurement as little as possible on account of their material characteristics and shape. Such an interface permits a humidity compensation between the sensor surface and the surrounding medium, whilst influencing the measurement as little possible, in particular on account of thermal characteristics.

Materials which bear on the sensor or at least on the regions of the sensor which are of relevance to the measurement, as tightly as possible, and which are capable of sucking up the moisture from the surrounding medium, for example earth, and also of releasing this again, are considered as an interface. Furthermore, the interface is mechanically deformable, so that it may adapt to a surface of a solid medium or solid matter quantity which is not clearly defined, and compensate for example impressions of stones or intermediate spaces, the inhomogeneous surface of a granular medium, such as gravel etc. A certain volume change of the surrounding medium, for example by way of drying out, or swelling, is also taken into account by way of this. With sensors with thermal measurement methods, the interface should furthermore have an as low as possible thermal capacity, additionally to the hydrophilic and soft design.

The not so well defined contact surface between the sensor and the surrounding is optimised, and the influence on the measurement which is negative because it is undefined, is eliminated or at least greatly reduced, by way of an interface.

A low thermal conductivity and thermal capacity is advantageous, in particular with thermal measurement methods, for example with ground humidity sensors with a heating element. It is thus ensured that a temperature change at the measurement sensor takes place on account of the humidity of the surrounding medium, and not on account of the thermal capacity of the interface. The interface preferably also has a thermal decoupling effect. This is in contrast to ceramics or also artificial earth, which themselves have a high thermal conductivity, and in the case of ceramics, permit no complete displacement of the air in the pores by moisture. A measurement is thus adulterated by way of “ceramic characteristics”. The interface or the materials from which it is manufactured, has yet further desired characteristics, depending on the sensor and the surrounding medium.

In a preferred embodiment, the interface is exchangeable and is designed as a material which may be pushed over a sensor or sensor head, and over the ceramic cap in the case of a tensiometer. This material may likewise be an interface shaped as a cap, e.g. a fingerstall, or may also be an interface composed of individual layers with openings for the measurement probe etc., depending on the shape of the sensor. The interface may also be firmly attached to a sensor/sensor head.

The material of the interface should easily absorb humidity of the surrounding medium and also release it again, so that no humidity difference occurs between the interface and the surrounding medium. Hydrophilic, open-pored material which in particular also has essentially the same pore size as the surrounding medium, is therefore suitable.

Since sensors are often exposed to a corrosive environment, the interface should also be as corrosion-resistant as possible, and be protected with regard to rotting. This is preferably achieved by way of using a suitable synthetic material, such as plastic, for example in the form of processed plastic fibres, as interface material. If the interface is to be fastened on a sensor, which is inserted into the earth, then the interface material also has a certain mechanical stability, in order not to easily tear or break on pressing into the earth. Depending on the type of sensor, e.g. with a measurement probe, the interface surrounding the measurement probe, as the case may be, may yet be surrounded by a stable, but very open mechanical support. This support, where possible, has no influence on a measurement, and preferably assumes a very small surface share of the sensor or of an effected measurement region. The support may be designed in a stable manner, preferably of a firm material, so that a sensor or an interface is protected by the tip of the support on insertion of the sensor into a firmer quantity of solid matter, such as compact earth.

An interface may also protect a sensor or sensor head, e.g. a present ceramic, from external influences such as scaling and the infestation of micro-organisms, but also from mechanical influences. An exchangeable interface may be replaced with very little effort with regard to cost, material and time, e.g. on account of wear and ageing of the interface, or with the use of the sensor in another medium.

The ratio of the pores or intermediate spaces or passages in the material, to the quantity and the distribution of the material itself, where possible, should be optimised in a manner such that the material influences a humidity exchange solid matter medium/interface as little as possible. This is particularly the case with interfaces which are manufactured of fibres such as felt, gauze, nonwovens, knitted fabrics or woven fabrics.

A further advantage of an interface is the fact that conventional sensors may be provided with this, and thus their accuracy and in particular reliability is significantly increased. Moreover, such interfaces may be manufactured in a very economical manner.

It is because of the interface that the contact surface between the sensor and the surrounding medium is optimised or increased in size, or, as in the case of the reduction of volume of the surrounding medium, for example due to shrinkage of the earth due to drying out, that the contact is created and ensured.

### BRIEF DESCRIPTION OF THE DRAWINGS

The invention is hereinafter represented by way of exemplary figures.

FIG. 1 is a tensiometer; and

FIG. 2 is a cut-out of a sensor tip.

### DETAILED DESCRIPTION OF THE PREFERRED EMBODIMENTS

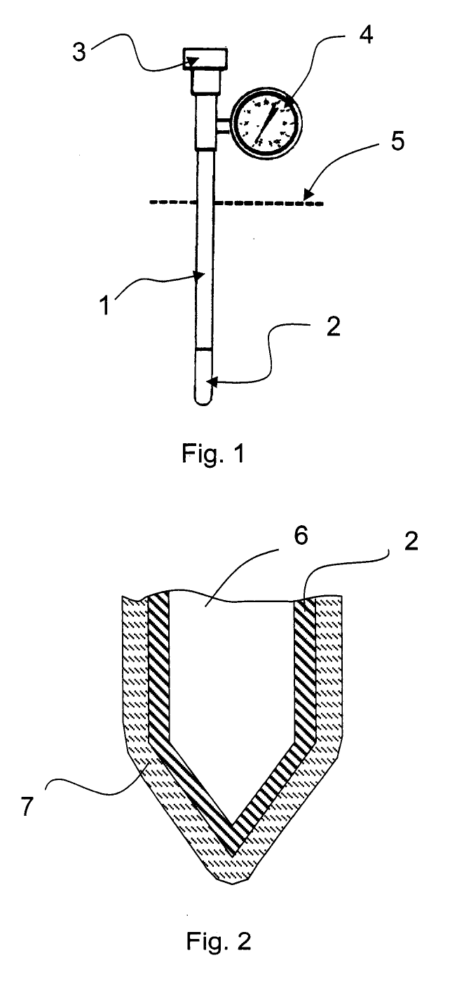

FIG. 1 shows a tensiometer. A tube 1 filled with water is closed off at its lower end by a cap of porous ceramic 2. The lower end is located at a certain depth below the surface of the ground 5. The water filling opening which may be closed in an airtight manner by way of a closure 3, is located at the upper end of the tensiometer. A manometer 4 is also attached in the upper region, on which one may read off the pressure prevailing in the tube 1. Water is then pressed through the ceramic cap 2 out of the tensiometer into the ground, depending on the humidity of the ground. A disequilibrium of humidity always effects a pressure change in the tube 1, which may be read off at the manometer 4. The interaction of the humidity is however only ensured given an optimal contact between the ceramic cap 2 and the surrounding earth.

FIG. 2 shows a section through an inventive embodiment of the frontmost part of the sensor tip of a tensiometer as from FIG. 1. One recognises the hollow, porous ceramic cap 2 which is filled with water 6 and which is coated with felt 7. The felt 7 may be designed in the form of a felt cap which may be pushed over the ceramic cap 2 and which is attached on the sensor in an exchangeable or also fixed manner. Given a suitable section of the felt 7, this easily absorbs moisture and releases it again, so that no humidity difference occurs between the felt 7 and the surrounding medium. Furthermore, one may use felts of plastic fibres which are largely resilient with regard to fungi and which do not rot. As soon as a felt 7 may no longer meet the requirements on account of ageing, it may be replaced and exchanged with little effort and at low cost. The felt 7 or other suitable materials, such as open-pored polyurethane foam, gauzes, knitted fabrics and woven fabrics, in particular wound nonwovens and those manufactured of plastic fibres, have a thickness in a range of 1 to 10 mm, typically 3-7 mm, e.g. 5 mm. The thickness may be adapted accordingly, depending on the type of sensor and the surrounding solid matter quantity. The softness or mechanical flexibility of the interface permits an adaptation to the undefined, non-uniform, granular surface of earth or other solid matter media such as cereals for example. A certain volume reduction of the surrounding earth on account of drying out is compensated with the flexibility of the interface, and on account of this, it is particularly the size of the contact surface which is defined, or this is always kept essentially at the same size.

1-12. (canceled)

13. A sensor for measuring the water content or humidity content of a solid matter medium which at least partly surrounds the sensor, wherein the region of the sensor which is designed for measurement is surrounded by an interface material, said interface material being designed to take up and release moisture as well as being designed in an elastically deformable manner, and whose thickness is selected in a manner such that the interface may be mechanically coupled to a non-constant or not clearly defined surface of a solid matter medium at least partly surrounding the sensor, so that a contact surface between the sensor and solid matter medium may be optimised by way of this.

14. A sensor according to claim 13, wherein the interface is exchangeably attached on the sensor.

15. A sensor according to claim 13, wherein the interface material has a low thermal capacity and thermal conductivity, and these are selected in a manner such that one may achieve a thermal decoupling from a surrounding medium.

16. A sensor according to claim 13, wherein the interface material is formed as a covering.

17. A sensor according to claim 13, wherein the region of the sensor which is designed for measurement comprises a porous ceramic and the ceramic is coated with the interface material.

18. A sensor according to claim 13, wherein the interface material is manufactured of fibers selected from a group consisting of: gauze, nonwovens, knitted fabrics and woven fabrics.

19. The use of the sensor according to claim 13, in a solid matter medium with a certain pore size, wherein the interface material is open-pored and essentially has the same pore size as that of the surrounding solid matter medium.

20. The use of a sensor according to claim 13 as a ground humidity sensor or tensiometer.

21. A device for use with a sensor for measuring water or humidity of a solid matter medium, wherein the device contains open-pored material which takes up and releases moisture and is elastically deformable, such that the device is attached to a sensor in a flush manner and forms an interface between the sensor or parts thereof, and the surrounding solid matter medium, and whose thickness is selected such that it may be mechanically elastically coupled to a non-constant or not clearly defined surface of a solid matter medium which at least partly surrounds the sensor, in order to form an optimised contact surface between the sensor and the solid matter medium.

22. A device according to claim 21, manufactured of fibers selected from a group consisting of: felt, gauze, nonwovens, knitted fabrics and woven fabrics.

23. A device according to claim 21, wherein the device is made of synthetic material.

24. A device according to claim 21, wherein the device has a thickness between 1 and 10 mm.

25. A device according to claim 24, wherein the device is made of synthetic material and manufactured of fibers selected from a group consisting of: felt, gauze, nonwovens, knitted fabrics and woven fabrics.

26. The use of a device according to claim 21, for the flush coating of at least parts of a sensor, as an interface between a sensor surface and a surface of a solid matter medium surrounding the sensor.

27. The use of a device according to claim 25, for the flush coating of at least parts of a sensor, as an interface between a sensor surface and a surface of a solid matter medium surrounding the sensor.

28. A sensor according to claim 14, wherein the interface material has a low thermal capacity and thermal conductivity, and these are selected in a manner such that one may achieve a thermal decoupling from a surrounding medium.
